(19) United States
(12) Patent Application Publication
(10) Pub. No.: US 2005/0062907 A1
(43) Pub. Date: Mar. 24, 2005

(54) Liquid crystal display device

(76) Inventors: Kohji Matsuoka, Suzuka-shi (JP); Hiroyuki Kitayama, Tsu-shi (JP); Kazushige Miyamoto, Tsu-shi (JP)

Correspondence Address: BIRCH STEWART KOLASCH & BIRCH, PO BOX 747, FALLS CHURCH, VA, 22040-0747, US

(21) Appl. No.: 10/944,784

(22) Filed: Sep. 21, 2004

(30) Foreign Application Priority Data
Sep. 22, 2003 (JP) 2003-329358
Jul. 6, 2004 (JP) 2004-198880

(51) Int. Cl. G02F 1/1335

(52) U.S. Cl. 349/106

(57) ABSTRACT

According to the invention, after a transparent electrode is vapor-deposited over the entire color-filter side surface, a non-conductive film is laid where the presence of the transparent electrode causes problems. That is, this non-conductive film is formed of the same material and at the same time as an alignment regulation film over the whole or a part of the area where exposure of the transparent electrode causes problems so as to seal the transparent electrode there. This makes it possible to prevent the above-mentioned problems caused when the transparent electrode is vapor-deposited over the entire surface, and simultaneously to enhance the patterning accuracy up to the exposure accuracy (of the order of several μm) of proximity or the like so as to realize a product with a narrow frame.

This nonprovisional application claims priority under 35 U.S.C. § 119(a) on patent applications Nos. 2003-329358 and 2004-198880 filed in Japan on Sep. 22, 2003 and Jul. 6, 2004, respectively, the entire contents of which are hereby incorporated by reference.

### BACKGROUND OF THE INVENTION

1. Field of the Invention

The present invention relates to a liquid crystal display device such as a liquid crystal display. In particular, the present invention relates to the structure of a color filter a liquid crystal display device.

2. Description of Related Art

In recent years, liquid crystal displays (LCDs) have been rapidly widening the scope of their application thanks to their advantages such as light weight, slimness, low power consumption, low-voltage driving, and little influence on the human body. Among such liquid crystal displays, color liquid crystal displays, in particular, continue increasing their use strikingly rapidly as more and more of them are used to achieve color display in personal computers and in various appliances ready for multimedia.

Today, color liquid crystal displays industrially put into practical use can be classified, according to their display mode and driving method, into several types. Two common types are the one adopting the active matrix (AM) method exploiting the twisted nematic (TN) mode and the one adopting the multiplex method exploiting the super twisted nematic (STN) mode. There have been proposed various other liquid crystal driving methods, and color liquid crystal displays adopting various methods have come to be manufactured increasingly eagerly by different manufacturers.

In the TN and STN modes, color display is achieved on the same principle. Specifically, each display pixel is divided into dots corresponding to three primary colors, and the voltage applied to the liquid crystal layer at each of those divided dots is controlled so that the light transmissivity at that dot is controlled. The three primary colors for which the light transmissivity is controlled separately in this way mix together to produce the color displayed at that pixel. The three primary colors are, typically, red (R), green (G), and blue (B). Other liquid crystal driving methods achieve color display basically on the same principle, and are thus similar to those exploiting the TN and STN modes.

At each dot, only that one of the three primary colors which corresponds to that particular dot needs to be transmitted. This is achieved by the use of a color filter (CF). An LCD has two support substrates of mainly glass or the like laid together, and the CF is formed on that surface of one of the substrates which makes contact with liquid crystal. In general, in an AM-LCD, the CF is formed on that substrate (opposing substrate) on which no thin-film transistors (TFTs) or diodes (MIM) are formed; in an STN-LCD, the CF is formed on either one of the two substrates having stripes formed thereon.

Now, the individual elements that make up the LCD will be described. On the CF, a coloring layer is laid that consists of patches each colored in one of the primary colors, namely red (R), green (G), and blue (B). In the gaps between differently colored patches, in any part of the coloring layer where leakage of light needs to be prevented, and along the edges of the display region of the LCD, a black matrix (BM) is formed for the purpose of shielding light.

The coloring layer and the BM are formed in one of the following ways. Most commonly, first, on top of a support substrate, the BM is formed, and then, further on top, the coloring layer is formed. Alternatively, first, on top of a support substrate, the coloring layer is formed, and then the BM is formed so as to fill the gaps between the colored patches of the coloring layer.

After the formation of the coloring layer and the BM, the surface of the CF may be flattened by forming an overcoat layer (OC) on top of the coloring layer and the BM. However, forming the OC not only requires an extra manufacturing step, but also lowers the yield, greatly increasing the manufacturing cost of the CF. Thus, from the perspective of mass manufacture, it is best to omit the formation of the OC.

Subsequently, on top of the layers formed as described above, a transparent electrode is formed for driving liquid crystal. The transparent electrode is typically formed of indium tin oxide (ITO). In a TFT-LCD, the ITO is so patterned as to cover almost the entire surface. It is typically vapor-deposited by using a mask to permit partial patterning. In a MIM-LCD or STN-LCD, the ITO is patterned in stripes.

Further on top of the ITO, a resin material such as acrylic may be so patterned as to partially cover the active area and the frame. This pattern serves to achieve alignment regulation in a case where a vertical-alignment liquid crystal is used, as is often the case in modem television, computer, and other monitors. In addition to this pattern, columns of acrylic or the like may be sandwiched between the array-side part and the CF-side part so as to support them relative to each other. These columns are patterned on top of the ITO, which is located on the CF side, so as to partially cover the active area and the frame.

The black matrix (BM) is formed of a metal such as chromium or a black resin. In recent years, however, the toxicity of chromium has produced much concern, and a two-layer structure formed of nickel and tungsten laid over each other has come to be used more commonly. This structure has nickel laid on the display side, and has tungsten, which has extremely high reflectivity, on the array side. Here, irrespective of the material used, an optical density (OD) of about 3 or more is needed to achieve satisfactory light shielding. To obtain such a high OD, a metallic chromium layer needs to be given a film thickness of about 0.1 μm or more, and a black resin layer about 1 to 2 μm or more.

In recent years, as metallic tantalum becomes increasingly rare and expensive, aluminum, which offers high reflectivity despite being lowly resistive and inexpensive, has come to be increasingly used. This material, however, when used in combination with a high-reflectivity BM material, causes multiple reflection, resulting in a problem called a characteristic mismatch. To avoid this, there has been much demand for lower reflectivity in the CF-side BM. Correspondingly, BMs have come to be given increasingly low reflectivity.

A preferred material for a low-reflectivity BM is a black resin, because it has the following desirable properties. As compared with metallic chromium, which has a reflectivity of 60%, a black resin has an extremely low reflectivity of 1% to 3%, permits the reflected spectrum to depend less on wavelength, and has a neutral black hue. Disadvantageously, however, a BM formed of a black resin, with its comparatively greatly film thickness, namely 1 to 2 μm, degrades the flatness of the CF surface.

Another way to obtain low reflectivity is to use a BM formed of chromium oxide and metallic chrome laid over each other, or to use a BM formed of nickel and tungsten laid over each other. Disadvantageously, however, these BMs have reflectivities of 3% to 5%, which are somewhat higher than that of a black resin BM, and moreover their reflectivity depends on wavelength, giving them a bluish or purplish hue rather than a neutral black one. Also disadvantageous is their requiring a film formation process in which typically two metal-based layers are formed by sputtering, leading to lower productivity and higher cost.

A BM of a black resin can be formed on top of a support substrate by one of several methods, of which some representative examples will be described below.

According to a first method, first, a film of a negatively photosensitive black resin is formed on top of the support substrate. This black resin film is formed, for example, by application performed by the use of a spin coater; by bonding of a previously prepared film of black resist over the support substrate; or by cascade application. Next, the surface of the support substrate is irradiated with ultraviolet rays through a photomask with a predetermined BM pattern so that the exposed part of the black resin is cured. Subsequently, the unexposed part of the black resin is developed and is thereby removed. In this way, the BM is formed.

According to a second method, first, in a manner similar to that adopted in the first method, a film of an uncolored, negatively photosensitive resin is formed on top of the support substrate. Next, in a manner similar to that adopted in the first method, exposure and development are performed to pattern the prototype of a BM. Subsequently, the patterned part is colored black. The coloring here is achieved by electroless plating, dyeing, or like.

According to a third method, first, in a manner similar to that adopted in the first method, a film of a developable black resin is formed on top of a support substrate. Next, further on top of this surface, positively photosensitive photoresist is formed, and then, in a manner similar to that adopted in the first method, exposure and development are performed. During the development, as the exposed part of the photoresist is removed, the corresponding part of the black resin is removed together. Then, the black resin is cured through crosslinking achieved by application of heat, and, subsequently, the unexposed part of the photoresist is removed.

A coloring layer can be formed, for example, by forming on the substrate a film of a resin having a pigment previously dispersed in it and then patterning it into a predetermined shape by photolithography (i.e., by pigment dispersion); by forming on the substrate a film of a photosensitive resin, then patterning it, and then dyeing it; by printing on the substrate a predetermined pattern of a resin having a pigment previously dispersed in it (i.e., by printing); by dispersing a pigment and a resin in a liquid and forming a predetermined pattern on the substrate by electrodeposition; by bonding to the support substrate a previously prepared film of colored resist (i.e., by DFL, or dry film lamination); or by spraying a jet of ink.

After the BM and the coloring layer have been processed as described above, a magnet is placed usually on that side of the support substrate opposite to the film surface, and the support substrate is placed on top of the magnet. Then, a metal deposition mask is placed further on top of the support substrate, and the transparent electrode is vapor-deposited over the entire surface. The metal deposition mask is kept in intimate contact with the support substrate by the magnetism exerted by the magnet. This helps alleviate unsharp edges.

Further on top of the ITO, a film of a resin such as acrylic for alignment regulation is deposited in a manner similar to that by which the BM and the coloring layer are formed. Subsequently, through exposure and development, patterning is performed, and then, through sintering, the product is solidified and is thereby finished. This process is not necessary in a case where alignment regulation is achieved with a type of liquid crystal other than the vertical-alignment type. The columnar pattern is formed in a manner similar to that by which the resin film is formed.

There have been proposed techniques of accurately patterning a transparent electrode on top of a color filter through exposure of positive resist (for example, Japanese Patent Application No. H3-17621).

When a color filter (CF) is produced, first a coloring material and a BM are formed, and then a transparent electrode is vapor-deposited. The vapor deposition here is performed with a mask placed on the surface. When vapor deposition is performed in this way, the deposited pattern has dimensional errors, when expressed as the sum of the degree of unsharpness and the degree of deviation, as great as 500 μm to 1,000 μm, which thus eat up design margins.

This can be avoided by performing vapor deposition over the entire surface and then performing patterning through exposure, development, and etching. This can be achieved, for example, through backside exposure as proposed in Japanese Patent Application No. H3-17621 mentioned above, or through ordinary film surface exposure. Using these techniques here, however, lead to greatly increased cost.

Another way is to vapor-deposit the transparent electrode over the entire surface. This, however, may result in electrolytic corrosion attributable to a liquid or the like left at the interface with the array-side part. Moreover, at the frame, or somewhere between the frame and the CF breakage faces located further outside, unwanted electric conduction to an array-side electrode may occur by way of a foreign object or the like or, in a case where a conducting material is used as a sealing resin, by way of the seal. This increases the incidence of defects attributable to electric leakage.

FIG. 4 shows how electrolytic corrosion occurs. FIG. 4 is a sectional view showing the basic construction of a conventional liquid crystal display device. In FIG. 4, reference numeral 1 represents a support substrate (on the CF side), and reference numeral 2 represents a support substrate (on the array side). On the inner surface of the support substrate 1, there are provided an active area 3 that constitutes the display screen and a frame 4 that surrounds the active area 3. Further inside these is provided a CF-side transparent electrode 5 formed of ITO or the like. On that part of the CF-side transparent electrode 5 corresponding to the active area 3, there are provided projection-shaped ribs 15 as one example of an alignment regulation film for regulating the alignment of liquid crystal, and column-shaped members 11 that support the CF-side and array-side parts relative to each other. These ribs 15 are formed only in a case where a vertical-alignment liquid crystal is used as a liquid crystal material. On the top surface of the CF-side transparent electrode 5, the column-shaped members 11, and the ribs 15, an alignment film 6 formed of polyimide (PI) or the like is laid.

On the other hand, on the inner surface of the support substrate 2, there are provided a wiring pattern and an array-side film 7. On the part of the wiring pattern and the array-side film 7 corresponding to the active area 3 is provided an array-side transparent electrode 8 formed of ITO or the like, and on the top surface of the wiring pattern, array-side film 7, and array-side transparent electrode 8 is provided an alignment film 9 formed of polyimide (PI) or the like. Between the alignment films 6 and 9, a liquid crystal layer 10 is sealed. The column-shaped members 11 are sandwiched between the alignment films 6 and 9 so as to support the CF-side and array-side parts relative to each other. The liquid crystal layer 10 is surrounded by a seal region 12. If, as shown in FIG. 4, a liquid 13 such as water or a solvent containing a conductive material seeps between the CF-side transparent electrode 5, on one hand, and the wiring pattern or array-side film 7, on the other, electrolytic corrosion occurs between them.

In Japanese Patent Application No. H3-17621 mentioned above, in a case where the seal region reaches above the BM, the transparent electrode extends beyond the alignment film formed of polyimide (PI) or the like. If, to seal this transparent electrode, the polyimide also is so laid as to extend beyond, the contact strength with the seal becomes so weak that the margin against exfoliation becomes extremely poor. By contrast, if the transparent electrode is extended to reach the BM edges without being sealed by the polyimide, it conducts to the array-side part by way of a foreign object or the seal, making defects attributable to electrical leakage more likely.

The technique disclosed in Japanese Patent Application No. H3-17621 mentioned above can be do away with by laying positive resist not on the back surface but on the film surface and performing exposure, development, and cleaning from the film-surface side. Processing with positive resist, however, is not usually used, because it produces an extremely great process loss, leading to increased cost.

### SUMMARY OF THE INVENTION

In view of the conventionally encountered problems discussed above, it is an object of the present invention to provide a liquid crystal display device that has a simple construction, that permits highly accurate patterning, and that can prevent electric leakage and electrolytic corrosion from occurring at electrodes.

To achieve the above object, according to the present invention, after a transparent electrode is vapor-deposited over the entire surface, a non-conductive film is laid where the presence of the transparent electrode causes problems. An increasingly commonly used method for driving liquid crystal today is by using a vertical-alignment liquid crystal and forming, on the transparent electrode, a projection-studded alignment regulation film for regulating the alignment of liquid crystal. According to the invention, the non-conductive film is formed of the same material and at the same time as the alignment regulation film over the whole or a part of the area where exposure of the transparent electrode causes problems so as to seal the transparent electrode there.

This makes it possible to prevent the above-mentioned problems caused when the transparent electrode is vapor-deposited over the entire surface, and simultaneously to enhance the patterning accuracy up to the exposure accuracy (of the order of several μm) of proximity or the like so as to realize a product with a narrow frame. With respect to the non-conductive film, however, even when the alignment regulation film is not necessary, the support member for supporting the color-filter-side and array-side parts relative to each other is customarily left on the transparent electrode. Accordingly, the non-conductive film may be formed of the same material as the support member at the same time as the alignment regulation film.

### BRIEF DESCRIPTION OF THE DRAWINGS

FIG. 1 is a sectional view showing the basic construction of a liquid crystal display device embodying the invention;

FIG. 2 is a sectional view showing the basic construction of a liquid crystal display device in a case where no non-conductive film is patterned in a region corresponding to where no array-side wiring pattern is laid;

FIG. 3 is a sectional view showing the basic construction of a liquid crystal display device having plastic beads; and

FIG. 4 is a sectional view showing the basic construction of a conventional liquid crystal display device.

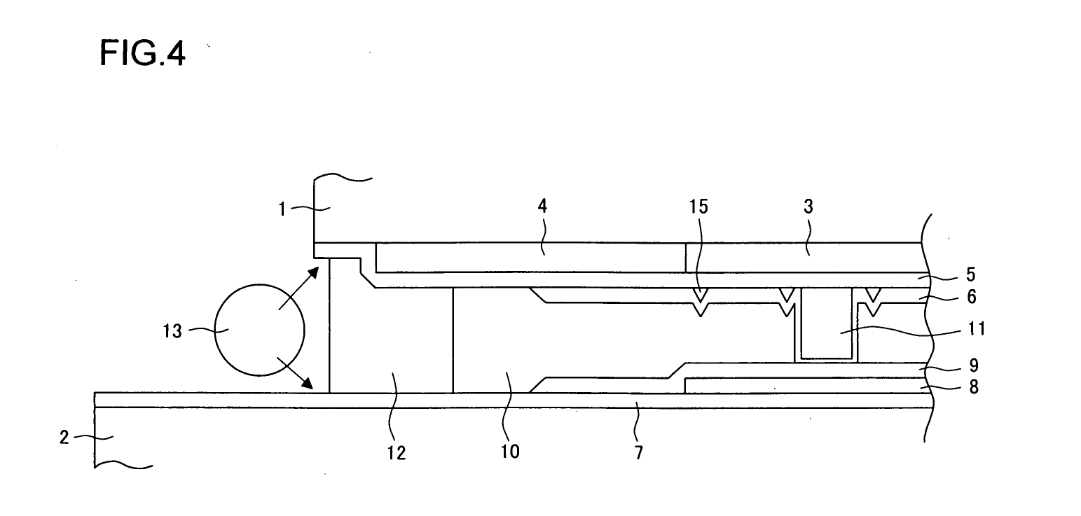

### DETAILED DESCRIPTION OF PREFERRED EMBODIMENTS

Hereinafter, embodiments of the present invention will be described with reference to the drawings. In the following description, such components as are found also in the conventional example described earlier are identified with common reference numerals, and their detailed explanations are not repeated.

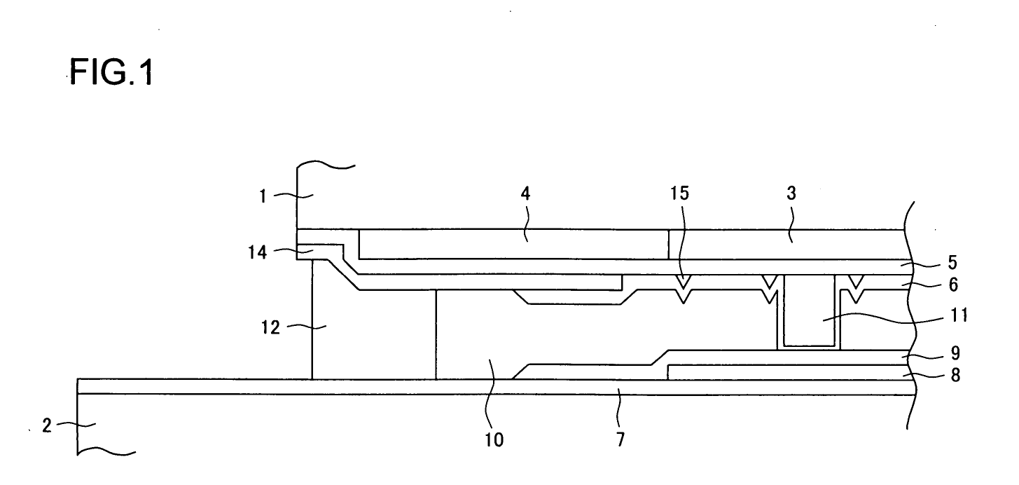

As shown in FIG. 1, in a liquid crystal display device embodying the invention, a non-conductive film 14 made of resin such as acrylic is laid on the CF-side transparent electrode 5, in a part thereof near the edges. That is, the CF-side transparent electrode 5 is left up to the CF breakage faces, and the non-conductive film 14 is laid in a region extending from part of the frame 4 to the CF breakage faces. This prevents electric leakage from being caused by way of a foreign object or electrolytic corrosion from being caused by residual moisture or the like between the CF-side transparent electrode 5 and a part of the array-side substrate opposite thereto where the electrode is exposed. Moreover, even when exfoliation of the electrode or the like occurs near the CF breakage faces, no electric leakage results.

Moreover, on top of the CF-side transparent electrode 5, projection-shaped ribs 15, which serve as an alignment regulation film for regulating the alignment of the liquid crystal sealed in the liquid crystal layer 10, are formed at regular intervals. These ribs 15 are formed only in a case where a vertical-alignment liquid crystal is used as a liquid crystal material. The ribs 15 may be formed on top of the array-side transparent electrode 8 as well as on the CF-side transparent electrode 5.

The ribs 15 are formed by first applying as a material therefor a positively photosensitive acrylic resin uniformly on top of the CF-side transparent electrode 5, and then performing photolithography on the part corresponding to the active area 3. During this process, the part corresponding to the region extending from part of the frame 4 to the CF breakage faces is formed as the non-conductive film 14. That is, the non-conductive film 14 is formed of the material of the ribs. Subsequently, on the part of the CF-side transparent electrode 5 corresponding to the active area 3, column-shaped members 11 are formed as support members. Then, the alignment films 6 and 9 are formed by printing respectively on, of the CF-side transparent electrode 5 having the ribs 15, non-conductive film 14, and column-shaped members 11 formed thereon and of the wiring pattern and array-side film 7 having the array-side transparent electrode 8 formed thereon, those parts which correspond to the active area 3 and part of the frame 4. Thus, on the surface of the alignment film 6 corresponding to the active area 3 appear, at regular intervals, projections that have the same shape as the ribs 15.

On the other hand, in a case where a twist nematic (TN) liquid crystal is used as a liquid crystal material, as opposed to in a case where a vertical-alignment liquid crystal is used, the ribs 15 are not formed on the CF-side transparent electrode 5. Thus, the material of the columns, namely a negatively photosensitive acrylic resin, of which the column-shaped members 11 are formed on the CF-side transparent electrode 5 are applied uniformly on top of the CF-side transparent electrode 5. During this process, the part corresponding to the region extending from part of the frame 4 to the CF breakage faces is formed as the non-conductive film 14. That is, the non-conductive film 14 is formed of the material of the columns. Then, the alignment films 6 and 9 are formed by printing respectively on, of the CF-side transparent electrode 5 having the non-conductive film 14 and column-shaped members 11 formed thereon and of the array-side transparent electrode 8, those parts which correspond to the active area 3 and part of the frame 4. In this way, when a twist nematic (TN) liquid crystal is used, the non-conductive film 14 is formed thicker by the thickness of the column-shaped members 11.

In the alignment film 6, the region where the CF-side transparent electrode 5 is exposed is usually only where a margin is secured for the region (common region) in which contact is made between the array-side and CF-side parts. Accordingly, in this embodiment, the alignment film 6 covers basically everywhere other than in the common region. However, if the alignment film 6 reaches the seal region 12, it is more likely to exfoliate. To prevent this, the non-conductive film 14 is necessarily formed from the edges of the alignment film 6 toward the seal. The non-conductive film 14 may be so formed as to almost reach the active area 3.

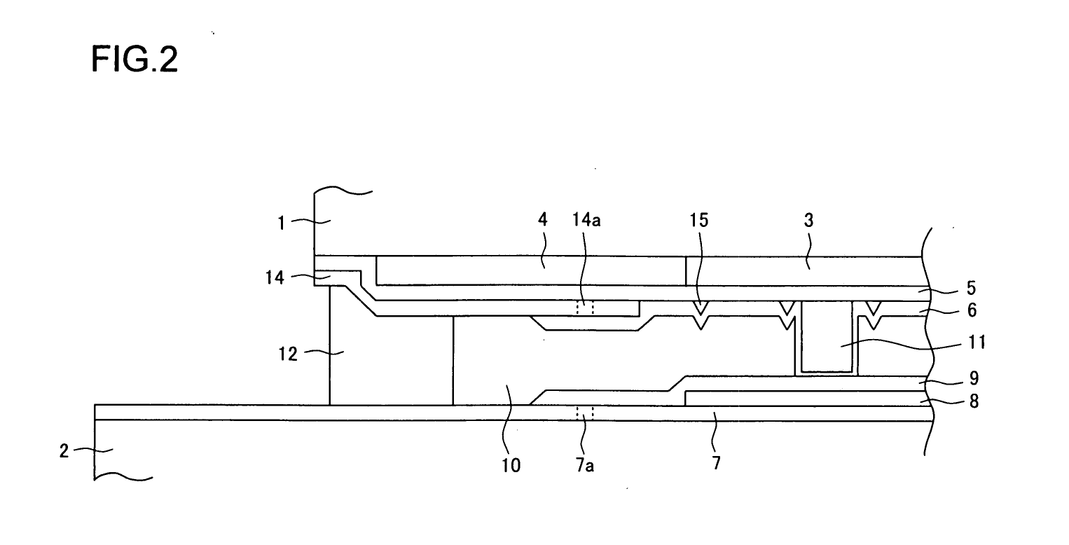

Depending on the pattern laid on the array side, no non-conductive film 14 is needed where no conductive film exists. Therefore, here, the non-conductive film 14 need not be patterned. FIG. 2 shows the basic construction of a liquid crystal display device in such a case. In FIG. 2, reference numeral 7a represents a region where no array-side wiring pattern is laid, and reference numeral 14a represents the region where, as a region corresponding to that where no array-side wiring pattern is laid, no non-conductive film 14 is patterned. In a case where no non-conductive film 14 is patterned, any pattern may be adopted. Moreover, irrespective of the array-side pattern, the non-conductive film 14 may be left out with respect to the seal region 12.

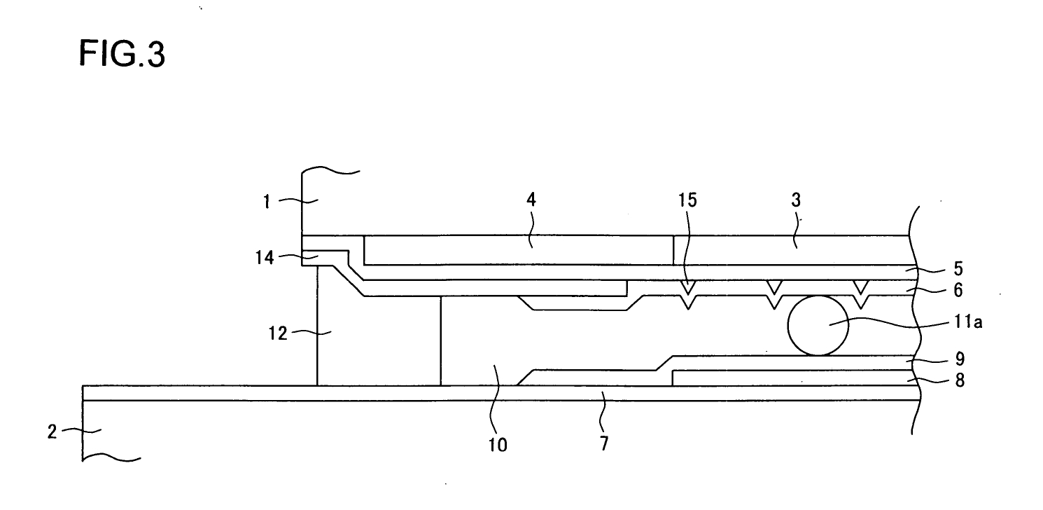

This embodiment deals with a case where a BM material exists as a primer layer. For lower cost, however, the BM material may be omitted. The coloring materials of the primer layer are not limited to red, green, and blue, but may be, for example, cyan, magenta, and yellow. The coloring materials of the prier layer are not limited to three colors, but may be two, four, or any other number of colors. The column-shaped members 11 that are sandwiched between the CF-side support substrate 1 and the array-side support substrate 2 so as to serve as support members for supporting them may be formed by laying coloring materials on top of one another. Alternatively, as shown in FIG. 3, the column-shaped members 11 may be replaced with plastic beads 11a. In this case, in the liquid crystal display device shown in FIG. 3, as in the liquid crystal display device shown in FIG. 1, first the non-conductive film 14 is formed on top of the CF-side transparent electrode 5, and then the alignment films 6 and 9 are formed by printing on top of the CF-side transparent electrode 5 and the array-side transparent electrode 8. Thereafter, the plastic beads 11a are formed between the alignment films 6 and 9.

A liquid crystal display device having plastic beads 11a does not necessarily have to be constructed as shown in FIG. 3, which shows as a mere example a modified version of the construction shown in FIG. 1, but may be constructed in any other manner; for example, the liquid crystal display device shown in FIG. 2 may be modified by replacing the column-shaped members 11 with plastic beads 11a.

When the liquid crystal display device provided with the non-conductive film 14 is constructed as described above, in a case where a vertical-alignment liquid crystal is used as a liquid crystal material, on the surface of the alignment film 6 appear, at regular intervals, projections that have the same shape as the ribs 15. Here, if the ribs 15 are made too thin, it is difficult to give the surface of the alignment film 6 a shape that effectively permits the vertical-alignment liquid crystal to align vertically. Accordingly, the ribs 15 need to be formed to have a thickness of 0.6 μm or more. Moreover, when the ribs 15 and the non-conductive film 14 are formed, because of errors attributable to the amount of the rib material applied, etching, and other factors, the non-conductive film 14 has a film thickness of 0.6 to 1.0 μm. In the liquid crystal display device shown in FIG. 1, the thickness of the liquid crystal cell is designed to be 1.5 μm or more to avoid electric leakage by way of a foreign object and other problems.

On the other hand, when a twist nematic (TN) liquid crystal is used as a liquid crystal material, the thickness of the liquid crystal cell is designed to have a thickness of 6.0 μm or less to prevent lowering of the response speed of the liquid crystal. To correspond to this liquid crystal cell thickness, the column-shaped members 11 are formed to have a thickness of 4.5 μm or less. Here, when an attempt is made to form the column-shaped members 11 so that they have a thickness of 4.5 μm, because of errors attributable to the amount of the column material applied, etching, and other factors, the non-conductive film 14 comes to have a film thickness of 4.5 to 5.5 μm. Accordingly, the non-conductive film 14 using the column material is so formed as to have a film thickness of 5.5 μm or less.

Based on the foregoing, in this embodiment, it is preferable that the non-conductive film 14 be given a film thickness in the range from 0.6 μm to 5.5 μm.

Moreover, when a vertical-alignment liquid crystal is used as a liquid crystal material, it is preferable that the liquid crystal cell thickness be deigned to be 4.0 μm or less. This is because vertical-alignment liquid crystals are used in appliances (for examples, television, computer, and other monitors) that require higher speed than is achieved with twist nematic (TN) liquid crystals. And, when the liquid crystal thickness is designed to be 4.0 μm, the non-conductive film 14 is formed to have a film thickness of 2.0 μm or less. Accordingly, when a vertical-alignment liquid crystal is used as a liquid crystal material, it is further preferable that the non-conductive film 14 be given a film thickness in the range from 0.6 μm to 2.0 μm.

1. A liquid crystal display device comprising:
a color filter; and
a transparent electrode provided so as to correspond to the color filter and extending to a breakage face of the color filter;
wherein a non-conductive film is laid on the transparent electrode in a region extending from a frame to the breakage face.

2. The liquid crystal display device of claim 1,
wherein the non-conductive film covers elsewhere than in a region where contact is made between a color filter side and an array side opposite thereto.

3. The liquid crystal display device of claim 2,
wherein the non-conductive film is not provided in a region of the color filter side which corresponds to a region of the array side where no conductive film is provided.

4. The liquid crystal display device of claim 1,
wherein a projection-shaped alignment regulating film that regulates alignment of liquid crystal is formed on a surface of the transparent electrode, and
wherein the non-conductive film is formed of a same material and at a same time as the alignment regulating film.

5. The liquid crystal display device of claim 2,
wherein a projection-shaped alignment regulating film that regulates alignment of liquid crystal is formed on a surface of the transparent electrode, and
wherein the non-conductive film is formed of a same material and at a same time as the alignment regulating film.

6. The liquid crystal display device of claim 3,
wherein a projection-shaped alignment regulating film that regulates alignment of liquid crystal is formed on a surface of the transparent electrode, and
wherein the non-conductive film is formed of a same material and at a same time as the alignment regulating film.

7. The liquid crystal display device of claim 1,
wherein a supporting member is formed that, by being sandwiched between a color filter side and an array side opposite thereto, supports the color filter side and the array side relative to each other, and
wherein the non-conductive film is formed of a same material and at a same time as the supporting member.

8. The liquid crystal display device of claim 2,
wherein a supporting member is formed that, by being sandwiched between the color filter side and the array side opposite thereto, supports the color filter side and the array side relative to each other, and
wherein the non-conductive film is formed of a same material and at a same time as the supporting member.

9. The liquid crystal display device of claim 3,
wherein a supporting member is formed that, by being sandwiched between the color filter side and the array side opposite thereto, supports the color filter side and the array side relative to each other, and
wherein the non-conductive film is formed of a same material and at a same time as the supporting member.

10. The liquid crystal display device of claim 1,
wherein the non-conductive film is given a film thickness in a range from 0.6 μm to 5.5 μm.

11. The liquid crystal display device of claim 2,
wherein the non-conductive film is given a film thickness in a range from 0.6 μm to 5.5 μm.

12. The liquid crystal display device of claim 3,
wherein the non-conductive film is given a film thickness in a range from 0.6 μm to 5.5 μm.

13. The liquid crystal display device of claim 4,
wherein the non-conductive film is given a film thickness in a range from 0.6 μm to 5.5 μm.

14. The liquid crystal display device of claim 5,
wherein the non-conductive film is given a film thickness in a range from 0.6 μm to 5.5 μm.

15. The liquid crystal display device of claim 6,
wherein the non-conductive film is given a film thickness in a range from 0.6 μm to 5.5 μm.

16. The liquid crystal display device of claim 7,
wherein the non-conductive film is given a film thickness in a range from 0.6 μm to 5.5 μm.

17. The liquid crystal display device of claim 8,
wherein the non-conductive film is given a film thickness in a range from 0.6 μm to 5.5 m.

18. The liquid crystal display device of claim 9,
wherein the non-conductive film is given a film thickness in a range from 0.6 μm to 5.5 μm.
